(19) United States
(12) Patent Application Publication
(10) Pub. No.: US 2023/0410167 A1
(43) Pub. Date: Dec. 21, 2023

(54) DEVICE AND METHOD FOR IMPLEMENTING AN E-COMMERCE WEBSITE ON BOARD AN AIRCRAFT

(71) Applicant: AIRFREE, Montreuil-sous-Bois (FR)

(72) Inventors: Thomas HERON, Paris (FR); Yohan SCIUBUKGIAN, Montreuil-sous-Bois (FR); Etienne DE VERDELHAN, Montreuil-sous-Bois (FR)

(73) Assignee: AIRFREE, Montreuil-sous-Bois (FR)

(21) Appl. No.: 18/248,284

(22) PCT Filed: Oct. 8, 2021
(86) PCT No.: PCT/FR2021/000116

§ 371 Date: Apr. 7, 2023

(30) Foreign Application Priority Data
Oct. 9, 2020 (FR) FR2010330

(51) Int. Cl. G06Q 30/0601; H04W 24/08; H04W 4/42

(52) U.S. Cl. CPC G06Q 30/0603; G06Q 30/0633; H04W 4/42; H04W 24/08

(57) ABSTRACT

The invention relates to a device allowing passengers provided with computer terminals and located on board an aircraft to use an electronic commerce website comprising in particular servers hosted by a computer infrastructure located on the ground and capable of being interrogated from the aircraft by way of a limited-bandwidth communication link between the aircraft and the ground infrastructure, wherein the electronic commerce website consists of a semi-embedded electronic commerce server (denoted “SeeS” for short) consisting of two parts, namely, on the one hand, a component located on the ground and, on the other hand, a component embedded in the aircraft and configured to optimize communication with said ground component depending on the various phases of a flight.

### TECHNICAL FIELD OF THE INVENTION

The invention relates to the field of online commerce web servers and the use thereof under the specific conditions of airliners in flight.

The invention relates to a device and to a method and also to the hardware and software architecture needed to ensure the complete operation of an electronic commerce (or e-commerce) website on board an aircraft, in particular a commercial airliner during flight phases, by optimizing the use of the Internet connectivity available in the duly equipped airliner, which connectivity is at present limited and expensive. The invention aims in particular to allow passengers to make simple and fast in-flight purchases of products, in particular duty-free products.

The device according to the invention will be referred to below as “semi-embedded e-commerce server”, or “SeeS” for short. These terms are used only for convenience for the sole purpose of improving the readability and understandability of this document.

### PRIOR ART

Web Servers:

On current e-commerce websites, navigation and transactions use a technical structure that is nowadays highly conventional, involving the construction of HTTP requests. These will trigger, for each page, the downloading of new HTML data comprising links to images or JavaScript and CSS content along with the data to be displayed. Each request will thus bring about the downloading of external content, some of which may be of a significant size (images in particular).

Conventional websites also comprise numerous JavaScript trackers for advertising or user behavior analysis purposes. These trackers, which are present on all pages, generate a large number of connections and may also disrupt the operating speed of a website in the event of a slow Internet connection.

It has been noted that current e-commerce websites are not designed to be able to operate smoothly and quickly on a limited Internet connection, as is typically the case in an airliner in flight. This results in slow and tedious navigation for the user. This may even lead to the connection being interrupted and the user's session being lost, leading to an incomplete user experience, for example the inability to finalize a purchase.

Internet Connectivity in Airliners:

It is already known to install a computer server and a Wi-Fi network in an airliner so that passengers are able to use their personal device (smartphone, tablet, laptop) that has Wi-Fi, or touch terminals integrated into the airliner, to benefit from various on-board services, such as for example the broadcasting of films or even video game services, and sometimes Internet access to a ground service. To obtain Internet access to ground services, passengers use the captive Wi-Fi portal of the airliner to subscribe to a limited Internet usage plan (more often than not limited to a few megabytes of data traffic).

Access to the network present on board the airliner does not pose any particular problem, but the story is different for accessing services provided by servers located on the ground.

Airliner Internet connectivity is provided, in the vast majority of cases, by a satellite connection. There are some alternative solutions, in particular direct connection from the ground, but these are only available over a limited number of territories (in particular North America), and never over oceans. Satellite connection solutions are therefore the only ones available all around the globe, and any limitation of these solutions may be considered to be a limitation of the Internet connectivity of airliners in flight (in particular for the purposes of e-commerce and duty-free purchases).

Now, according to a study conducted by an independent firm (Euroconsult, 2016), the cost of one gigabyte (1 GB) of data traffic using a satellite between the ground and an airliner is prohibitive, around 50 USD. Considering that the average bandwidth consumption of a user session on a normal e-commerce site is relatively variable, but may be estimated at around twenty megabytes (20 MB) per user and per session at least, the cost per session and per user of transactions on board an airliner on an unmodified infrastructure without optimization would amount to around 1 USD.

Furthermore, satellite Internet connections have significant technical limitations compared to conventional fiber-optic, ADSL or 3/4G mobile Internet connections. These limitations result in lower speeds (that is to say the number of megabytes downloadable per second) and higher latency times (that is to say the time taken between the transmission of a request by the Internet browser and its response from the ground server). The network latency brought about by the satellite connection itself, plus the latency between the satellite contact point on the ground and the ground servers, may amount to a few hundred milliseconds, which is highly noticeable and constitutes a significant limiting factor on the user experience.

Finally, the geographical location where the website targeted by an HTTP request is hosted is generally supposed to be as close as possible to the user and, of course, this is hardly possible when the user is in an airliner in flight. The request then more often than not goes through a satellite connection. The airliner's computer infrastructure is connected, via an antenna located on the cabin, to a geostationary satellite that is itself connected, by radio, to a ground infrastructure and, through this, to the targeted website. As the airliner moves, the satellite that is used may change, as may therefore the ground contact points able to communicate with these various satellites and the Internet routes between these ground contact points and the website.

Proxy Servers:

One conventional approach for attempting to compensate for these limitations in terms of accessing e-commerce servers on the ground from an airliner in flight would be that of using “proxy” servers. However, these solutions also have limitations that prevent them from providing the targeted optimizations.

“Proxy cache” servers (also called proxy servers) may be used as proxies for allowing user equipment on a network (computer, smartphone, tablet, etc.) to access the Internet, returning the static elements that have already loaded (images, JavaScript, CSS) without having to retrieve them again from the servers in question. “Reverse proxy” servers, conversely, will make the static elements of a given server available to users. However, these devices will make available only elements that have already been requested a first time and, in this first access operation, the element has to be loaded from the main web server.

Another major limitation that should be noted is the inability of conventional proxy servers to operate with a secure end-to-end HTTPS protocol. Admittedly, “TLS termination proxy” servers provide the benefits of proxy servers while still allowing use of the HTTPS protocol on the portion of the communication taking place over the Internet, but they assume a specific configuration on user terminals (and are therefore intended for business use, for example). These servers therefore cannot be used under the conditions of a commercial flight, in particular for providing access to passengers from their personal terminals (smartphone, tablet, laptop).

Some proxy servers are installed in airliners, but therefore only eliminate redundancies at cabin level, and only among access operations to resources accessible in HTTP mode on the Internet. This measure as such is therefore insufficient for avoiding having to download large volumes of data upon each request, which will very quickly consume the quota of megabytes included in the plan chosen and purchased by the passenger, and generate unannounced service interruptions.

One approach could consist in forcing the loading of the cache of the proxy server by going through, in advance, all of the pages of an e-commerce site the in-flight use of which it is desirable to facilitate, when a good-quality Internet connection is available. This mode of operation is reminiscent of that of a CDN (Content Delivery Network) the purpose of which is to pre-distribute, on the Internet as close as possible to users, the static components of a website of which only some of the data change, for example real-time digital data. However, if this function is provided within an airliner, for safety reasons, the initiative necessarily comes from the local equipment, which “pulls” the elements to be prefetched, whereas they are “pushed” onto a CDN by the web server.

Although this method for prefetching the cache of a proxy is a step in the right direction, it however turns out to be insufficient. On the one hand, it does not solve the limitation relating to HTTPS: even if all of the static elements of the site have been prefetched, since subsequent requests are encrypted, the proxy server will not be able to identify the elements that it has already in its cache so as to avoid requesting them again. However, more broadly, if the method is used with a standard web server, designed and developed independently of this use with a proxy server for the purposes of optimized consumption of the limited Internet connection that connects them, the benefit will remain small and partial. Indeed, the proxy server itself has to find the changes that may occur in a mode not conceived for the implementation of a proxy cache. For example, the activation of a commercial promotion on a product may lead to a set of changes, including to static elements, if no effort has been made in terms of a technical design aimed at eliminating this effect as far as possible. It will also be understood that it would be more efficient for the server acting as proxy for accessing the main web server to be able to ask the server what has changed.

“Owa” Technology:

Document US 2018/241463 A1 discloses a wireless open communication architecture (“OWA”) between aircraft and ground stations, with the aim of offering, throughout the communication chain, a continuum with a very high communication quality equivalent to that which exists between ground stations. This architecture is based, on the one hand, on indirect communication implementing a communication network between a set of airliners in flight and the nearest ground station or satellite at a given time and, on the other hand, on on-board communication terminals that are specific so as to make them compatible with this OWA architecture. A computer or a conventional telephone of a user on board an airliner is thus not compatible with this OWA architecture, unless a specific hardware interface is connected thereto. In addition, the complexity of this architecture and the fact that a link has to go through a network of airliners possibly belonging to different airlines makes it unsuitable for use in the context of transactions between passengers and an e-commerce site on the ground, which require the transmission of personal and confidential information or financial information.

Moreover, the use of a meshed network of airliners as described in this prior-art document cannot be envisaged for the provision of an e-commerce service. Indeed, as part of the provision of such a service, the data presented to the passenger are airline-specific data. Furthermore, as part of the service, personal user data are collected (sometimes denoted using the acronym “PII” for “Personally Identifiable Information”). Whatever encryption means are implemented, it is unimaginable that an airline would agree to let these airline and passenger data transit via communication devices placed in airliners of competing airlines, especially with regard to PII data in the context created by what are known as the GDPR data regulations. These limitations, inter alia, doubtlessly explain why the communication architecture according to that document has never been implemented for conducting transactions between the passengers of an airliner and an e-commerce site, nor for any other application.

Ultimately, the OWA solution described in this prior-art document turns out to be largely unsuitable for use for e-commerce purposes. In addition, given the fundamental differences in architecture and mode of operation, those skilled in the art will not be able to adapt it for this purpose.

### Aims of the Invention

The invention aims to solve the various technical problems outlined above in the context of communication between communication terminals of passengers of an aircraft and an electronic commerce website located on the ground, by using, between the aircraft and the website on the ground, a communication infrastructure for the secure transfer of data that is dedicated to this purpose, in particular while complying with a one-way chain of responsibility. This is understood to mean that, in order to provide the service to its client A, the telecommunications operator providing the service does not involve its other clients (in particular other airlines and other airliners) whose interests potentially come into competition with those of its client A. The invention furthermore aims to implement an e-commerce service on board an aircraft operating in accordance with a conventional and existing communication architecture that does not require any particular investments or modifications. In particular, the invention should allow the use of an e-commerce site (browsing and purchases) on board an airliner in flight by greatly reducing network bandwidth consumption and latency, and do so without fundamentally modifying the existing communication infrastructure between airliners and the ground.

Another aim of the invention is to propose a system able to reduce or even eliminate service degradations and interruptions so as to offer the user a continuous and fluid transaction experience, in particular for the purchase of duty-free products using their single conventional communication terminal, of unmodified conventional laptop or mobile telephone type. A secondary aim is even for the invention to allow the use of a subset of the functionalities of the e-commerce site in airliners that do not have Internet connectivity.

Another aim of the invention is to propose a system capable of being industrialized and implemented in practice using existing satellite communication infrastructures, without resorting to major investments or to a hypothetical and transient communication network between airliners in flight.

### Principle of the Invention

The present invention goes against the abovementioned document from the prior art and proceeds from the principle that there is no (and that there will not be in the near future) very high speed planetary communication network covering all airlines, and that it is therefore necessary to develop a new system that is however based on the existing radiofrequency and satellite communication infrastructure.

Going beyond the limitations disclosed above and encountered with a conventional “proxy”, “proxy cache”, “reverse proxy” or even “TLS termination proxy” server, the invention proposes a SeeS that is based in principle on active collaboration between an embedded component on board the airliner and the ground server in order to optimize the use of the bandwidth actually available during the various phases of a flight.

As mentioned above, proxy servers operate autonomously, modifying the methods of access to web servers designed and implemented without taking into account this possibility of access through a proxy server. The TLS termination proxy requires a specific configuration of the client terminals but, apart from this caveat (for which it should be mentioned that it concerns only a marginal fraction of the fleet of equipment under consideration), all of this “proxy” equipment fits into a network, comprising servers and clients, designed and deployed independently and almost always prior to implementation thereof. They provide gains, in terms of performance and safety in particular, to installations that operate without them. The benefit is that of being able to use them with standard servers without modifying them, but this is also the origin of their limitations.

Conversely, the SeeS according to the invention is not an autonomous network device allowing optimized access, under the constrained conditions of an aircraft in the flight phase, to a pre-existing standard e-commerce server, but a set consisting of two parts, namely an embedded component and a ground component. Together, these two components provide the passengers on the flight with an e-commerce site by optimizing the use of the Internet connection between them, using conventional connectivity solutions when the airliner is on the ground and, when it is in flight, using limited and expensive connectivity solutions.

The embedded component of the SeeS retrieves specific parameters of the aircraft and of the flight in order to trigger possible exchanges with the ground component on the basis of the type of Internet connection in the current flight phase. The parameters used in one implementation include in particular the flight number (and therefore the route) or else the status of the airliner (on the ground, in flight, at high altitude) as transmitted by the measuring instruments.

Taking into account parameters specific to the flight and to the airliner makes it possible to optimize the way in which the data available on board are retrieved and made available to the terminals of the users, be these personal terminals belonging to the users or terminals made available to said users by the airline and integrated on board the airliner. The content of the e-commerce site may also be adapted depending on the flight, and even for each passenger depending on their upcoming connections or journeys.

When the airliner is on the ground before it takes off, the SeeS uses an Internet connection of a type usually available on the ground (for example of conventional 3G or 4G type) rather than its satellite connection, since this is cheaper and faster. The SeeS takes advantage of this phase before take-off to store high-volume data in the embedded component, such as product catalogs for example.

When the airliner is in flight, the embedded component will communicate with the ground component via a limited and expensive Internet connection (typically via satellite), but this communication will concern only a very small volume of data corresponding for example to the retrieval of the real-time stock of products, the creation of user accounts, the authentication of users, the validation of shopping carts or the finalization of payment transactions.

The optimization of the use of the satellite Internet connection made possible by the optimization of the data exchanges between the ground and embedded components forming the SeeS is made possible through their active collaboration, resulting from a design and an implementation for this purpose. The embedded component directly and explicitly calls upon the ground component, as seen above, depending on the phases of the flight.

At regular intervals, the embedded component of the SeeS interrogates the computer system of the airliner to ascertain the current flight phase and, in order to synchronize the data and the functions forming the e-commerce site, triggers a sequence of exchanges with the ground component, which differs depending on the flight phase. When the airliner is on the ground and a standard connection is available with a high speed and a low cost, it uses this and asks the ground component for full synchronization. When the airliner is in flight and only a satellite connection is available, which is expensive and has a low speed, it asks the ground component for partial synchronization, optimizing the use of the connection.

Moreover, during the flight phase, when a passenger finalizes a purchase and makes their payment, communication with the ground is triggered in order to conduct the transaction. Not only is this communication important for the user and immediately profitable for the e-commerce site, but, moreover, the data exchanged to conduct the transaction represent a low volume and a limited cost.

### Subject of the Invention

In principle, the subject of the invention is a device and a method for creating and making available an e-commerce web server that is able to be consulted and used for purchases (or any other transaction) from an airliner in flight under good use conditions for passengers (fluidity, response time), said use of the e-commerce site by passengers taking place, for example and without limitation, from a personal electronic terminal (smartphone, tablet or laptop) or from equipment of the airliner (such as the screens available to passengers for viewing information and films).

The semi-embedded e-commerce server (or ‘SeeS’), which is the subject of the invention, consists of two components, one embedded, the other on the ground, which are designed, produced, installed and operated so as to work together, by optimizing the use of the Internet connectivity between them, which is possibly of normal quality and cost when the airliner is on the ground but limited and expensive when the airliner is in flight, and while ensuring continuity of service in the event of intermittent Internet connectivity. The SeeS could even allow the correct operation of a possibly reduced set of e-commerce functionalities in airliners that do not have Internet connectivity (limitations and constraints could for example prove to be unavoidable in payment functions).

The SeeS, formed of an embedded part installed in the airliner and a ground part, will rely, for the exchanges between the two components, on advanced technical copying, “caching”, “prefetching”, replication, cloning, synchronization, API (application programming interface) and load distribution mechanisms or any other mechanism for achieving complementarity of the two components so as to provide a high-quality on-board e-commerce service with optimization of the limited and expensive Internet connection between them; said mechanisms being able to be implemented independently or complementarily.

In the available prior art, the Internet connectivity of the airliner is provided by satellites or by ground relays, but the invention encompasses any present or future Internet connectivity solution for airliners.

The SeeS ensures the end-to-end security of the exchanges between the terminal of the user and its ground component. Optionally, for the purpose of complying with personal data confidentiality, the implementation may even ensure that no personal data remain stored in the embedded component.

Finally, additionally, the data (commercial items and offers) able to be consulted by a passenger and the options offered to said passenger will depend on the flight and their trip with any connections and return flights, or even on their future trips and their next places of residence, so that said passenger is invited to purchase items that it will actually be possible to deliver to them, be this at their destination, during connections or at their next places of residence. This information relating to passengers and their journeys will be provided automatically by the airline operating the airliner. Depending on the computer systems of the airline, their operation and their technical integration with the SeeS, this information will be retrieved by the embedded component of the SeeS or by its ground component.

More specifically, the subject of the invention is therefore a device for passengers of an aircraft, comprising a set of computer terminals used (without an added physical interface) by the passengers and an electronic commerce website itself comprising in particular servers hosted by a computer infrastructure located on the ground and capable of being interrogated from the aircraft by way of a limited-bandwidth direct communication link between the aircraft and the ground infrastructure without going through a communication network with other aircraft, characterized in that the electronic commerce website consists of a semi-embedded electronic commerce server (denoted “SeeS” for short) consisting of two parts, namely, on the one hand, a component located on the ground and, on the other hand, a component embedded in the aircraft and configured to optimize communication with said ground component depending on the various phases of a flight.

According to one advantageous embodiment, said computer terminals use communication protocols that are local network protocols, in particular Wi-Fi and Ethernet protocols.

According to one embodiment, said limited-bandwidth direct communication link is a satellite communication link or a direct radiofrequency connection from the ground.

According to one embodiment, said embedded component is configured to retrieve, automatically and in real time, information about the current flight phase.

According to one embodiment, the data exchanges between the two components of the SeeS are differentiated according to flight phases, taken from among parked in the closed flight state, parked with flight open, passenger boarding, taxiing, take-off and climbing to cruising altitude, cruising phase, descent and landing, passenger disembarkation.

According to one embodiment, said embedded component is configured to automatically retrieve information regarding the airliner, the flight and the passengers, taken from among the following elements: unique identifier of the airliner (“tail number”), flight number, flight characteristic data (such as departure and arrival airports, departure time and scheduled arrival time), flight parameters, and, for each passenger: confidential personal data such as identifier, segments of the trip, connecting airports, return flights, next trips, next places of residence, loyalty card number.

According to one embodiment, said embedded component is configured, when the aircraft is on the ground, to download, from the ground component, high-volume data such as product catalogs, or updates to functions or the software of the embedded device, using said high-bandwidth direct Internet connection between the aircraft and the ground infrastructure.

According to one embodiment, said embedded component is configured, when the aircraft is in flight, to communicate with the ground component using said limited-bandwidth direct communication link to exchange low-volume data with said ground component.

According to one embodiment, said low-volume data comprise personal and confidential information related to the creation of user accounts, user authentication, real-time stock of products available on the electronic commerce site, validation of shopping carts or finalization of payment transactions, and information on differential updates to the data of the electronic commerce website.

According to one embodiment of the device, the two components of the SeeS are configured to implement copying, “caching”, “prefetching”, replication, cloning, synchronization, API and load distribution operations, so as to optimize the use of the Internet connection available between them in real time.

According to one embodiment, said computer terminals of the users comprise personal computer terminals such as smartphones, touchscreen tablets or laptops.

According to one variant embodiment, said computer terminals of the users comprise terminals integrated into the entertainment system on board the aircraft.

Advantageously, the embedded component and the ground component of the semi-embedded electronic commerce server are configured to encrypt the communication between them.

According to one embodiment, said electronic commerce website is designed in the form of a single-page web application running on the portable terminal of the user or on a terminal integrated into the airliner.

According to one embodiment, said embedded component is configured to test the availability of a direct connection between the computer network of the airliner and the ground component, allowing the computer network of the airliner to access the ground component immediately and without delay and, in the event of unavailability, to save the transactions of the users in a buffer memory so as to complete them when the connection is available again or via a ground communication link once the aircraft has landed.

Another subject of the invention is a method for implementing the device as described above, characterized in that it comprises steps of:
interacting with the computer system of the airliner to check whether direct and immediate radiofrequency communication with the ground infrastructure is permitted;
if so, for the embedded component of the device, checking, using the computer system of the aircraft, the status, in flight or on the ground, of the aircraft;
if the aircraft is on the ground, launching a complete data synchronization phase between the ground component and the embedded component using a high-bandwidth terrestrial communication link;
if the aircraft is in flight and a limited-bandwidth satellite communication link is available, launching a partial data synchronization phase between the ground component and the embedded component.

According to one embodiment of the method, the partial synchronization phase concerns low-volume data such as personal and confidential information related to the creation of user accounts, user authentication, validation of shopping carts or finalization of payment transactions.

According to one embodiment of the method, the partial synchronization phase concerns low-volume data such as information related to the real-time stock of products available on the electronic commerce site, or differential updates to the data of the electronic commerce website.

### General Description of the Invention

The semi-embedded e-commerce server (or “SeeS”) according to the invention consists of two complementary components, one embedded in the airliner (‘embedded component’) and the other on the ground (‘ground component’).

Embedded Component:

The embedded component installed on board the airliner performs the following functions:

Retrieval of the main parameters of the airliner, in order to determine in particular the current flight phase (in particular from among the phases known as parked with flight closed, parked with flight open and boarding, taxiing, take-off and climbing to cruising altitude, cruising phase, descent, landing, disembarkation);

When a fast and economical Internet connection is available, in particular on the ground, loading, completely or as completely as possible, the data forming the e-commerce site from the SeeS, in particular static and large elements;

When only a limited and expensive Internet connection is available, in particular in flight, optimized use of said connection, in particular for necessary differential updates, loading of dynamic or real-time information and exchanges of a transactional nature—the dynamic information may for example concern the stock status of items available on the e-commerce site, or promotions, and the exchanges said to be of a transactional nature cover for example user authentication, shopping cart validation or payment;

Making available content to the terminals of the users—these terminals may include for example screens integrated into the seats or personal terminals of the passengers (smartphones, tablets, laptops).

The embedded component of the SeeS is a novel device, in particular among devices installed in airliners. This device installed in the airliner is reserved exclusively for the use described in this document. The embedded component may, in practical implementation cases, be integrated into the on-board entertainment system (commonly called IFEC, acronym for “In-flight Entertainment & Connectivity”).

Ground Component:

The ground component of the SeeS provides the embedded component with the data and services required to perform the functions described above. In one implementation that allows its role to be clearly understood (but does not prevent other implementations), the ground component is not an e-commerce server itself, but a meta-site or site generator for creating instances of the e-commerce site that are accessible from the airliner via the embedded component of the SeeS, in particular during the flight phases. It should be noted that the same ground server assembly may perform the ground component function for a large number of embedded components corresponding to various airliners.

It is important to note that, for convenience, for the intelligibility of the presentation by analogy with conventional websites, reference may be made to the e-commerce website to which the SeeS allows access in flight under optimum use conditions, but that said website might not have any materialization, form or implementation in the form of a website accessible in the usual way. Such an instance will exist in most implementations but, in terms of its function, the ground component is not identifiable or reducible to this site, even if the two functionalities of ground component of the SeeS and web server directly accessible in a conventional manner without an SeeS are provided by the same server, set of servers or server application.

For the purposes of achieving the set aims of optimizing the use of in-flight connectivity, exchanges between the two components of the SeeS, namely the embedded component and the ground component, will take place according to different operating modes depending on the situations, that is to say in the successive phases of the flight (in a broad sense of the term including the preparatory stages on the ground and final stages after arrival), namely primarily the phases of parked with flight closed, parked with flight open and boarding, taxiing, take-off and climbing to cruising altitude, cruising phase, descent and landing, disembarkation.

Process of the Exchange Between the Two Components of the SeeS:

The ground components are available at all times to respond to requests from all embedded components. As mentioned above, more often than not, but without limitation, a set of servers will perform the function of a ground component for a set of embedded components, for example those of all SeeS of one and the same airline. If considering one of these embedded components and the corresponding ground component (that is to say potentially a server performing this role for a set of embedded components), the communication is always initiated by the embedded component. First and foremost, it is a conventional architecture between a server (the ground component of the SeeS) and a client (the embedded component of the SeeS). Moreover, it is imperative for safety reasons: airliner communication systems are designed such that it is impossible to send to them data from the ground, so that it is impossible to compromise their safety in this way. Finally, it is the embedded component that is able to determine the current flight phase based on the information that it receives from the computer systems of the airliner where it is installed and optimizes the use of the connection that is then available with the ground component by adapting the calls it makes thereto.

When the embedded component is installed and during stopovers, the SeeS will go through a complete synchronization or resynchronization phase. It takes advantage of the terrestrial connection that is then available, with a high speed and a limited cost, for example a 3G/4G connection. In most cases, this may take place as soon as the airliner is on the ground, but it may also be the case that, due to technical or financial limitations, this is possible for example only during maintenance visits of the airliner. During this complete synchronization phase, all of the data of the e-commerce site is loaded into the embedded component, along with functions validated for use in production on the airliner. This complete synchronization may technically take place in differential form, but it is important to take advantage of the availability of the high-speed and inexpensive terrestrial connection to load all the latest available validated data and functions into the embedded component of the SeeS.

In the flight phase, when the communication between the two components of the SeeS necessarily goes through a limited and expensive Internet connection, the objective is to transit only the most limited possible volume of data through it. This will involve, on the one hand, data updates at a regular interval chosen so as to offer the best compromise between data freshness and cost, depending on the commercial objectives of the airline and, on the other hand, the exchanges needed to conduct the transaction during the purchase. The SeeS will also comprise mechanisms (buffer memories, repeated connection attempts) to deal with temporary interruptions to the Internet connection and best guarantee continuity of use of the e-commerce site. As mentioned above, the SeeS will also allow use of the e-commerce site in the least degraded mode possible when no Internet connection is available in flight, for example by storing connection attempts and by making them when arriving on the ground after checking that the purchased items are still available.

### DETAILED DESCRIPTION OF THE INVENTION

The invention is described in more detail with the aid of the figures below, in which:

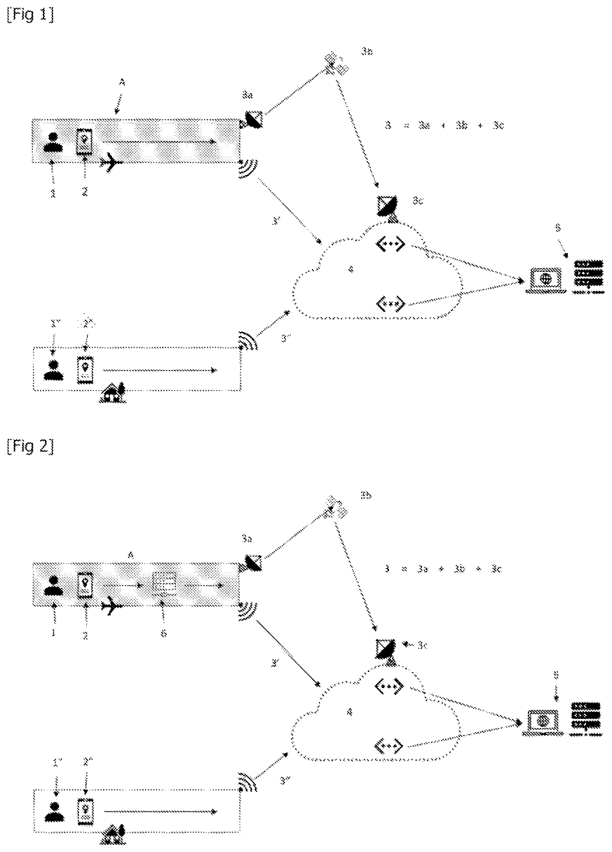

FIG. 1 schematically shows dual access to an e-commerce site from the ground and from an airliner without a device for optimizing this access, according to the prior art;

FIG. 2 schematically shows dual access to an e-commerce site from the ground and from an airliner with a proxy server, according to the prior art;

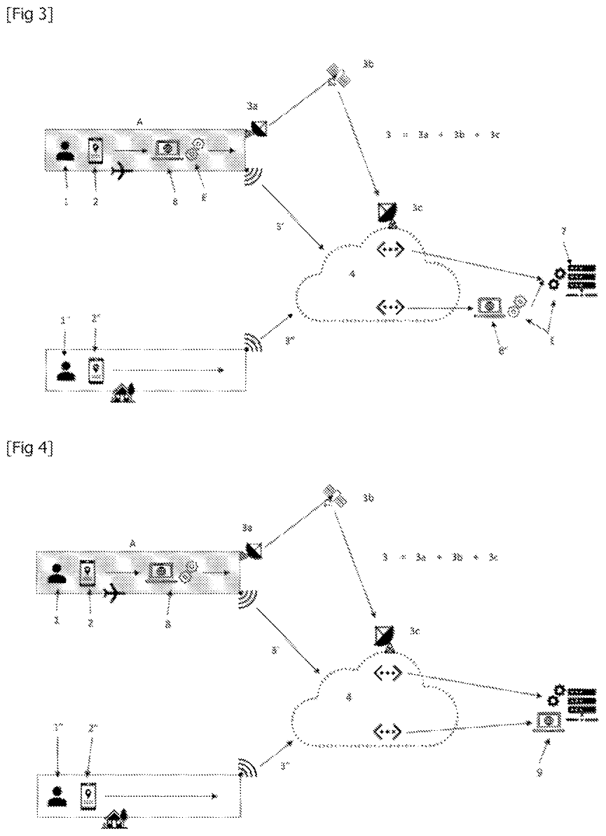

FIG. 3 schematically shows dual access to an e-commerce site from the ground and from an airliner with the SeeS according to the invention;

FIG. 4 schematically shows dual access to an e-commerce site from the ground and from an airliner with the SeeS according to one particular embodiment of the invention;

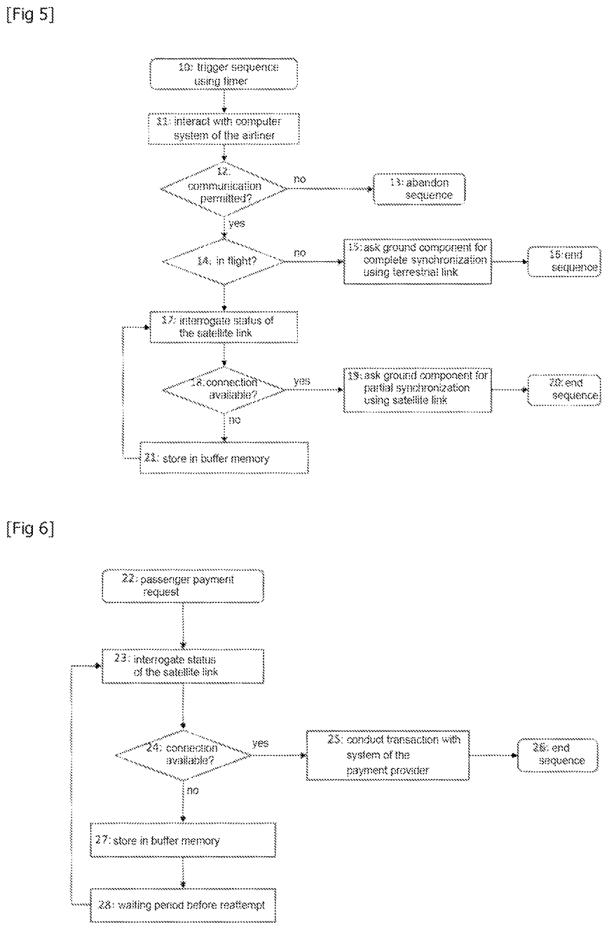

FIG. 5 shows a simplified model of the method for synchronizing the data and the functions of the e-commerce site implemented by the device according to the invention;

FIG. 6 shows a simplified model of the payment method implemented by the device according to the invention.

Device:

In FIG. 1, a passenger (1) of an airliner (A) is using a terminal (2) to access an e-commerce site (5). When the airliner (A) is on the ground, a high-speed and inexpensive terrestrial access network (3′) (for example of 3G/4G type) is available and used for communication between the terminal (2) and the e-commerce site (5) going through Internet operator networks on the ground (4). When the airliner (A) is in flight and the terrestrial access network (3′) is no longer available, the communication goes through a satellite link (3) implementing a transceiver equipment (3a) attached to the cabin of the airliner, a satellite (3b) or a set of satellites and transceiver equipment (3c) on the ground, and then through networks forming part of the Internet on the ground (4). When the airliner (A) is in flight, consulting the e-commerce site (5) therefore proves to be inconvenient and expensive.

For a user in their home (denoted 1″ and shown within the confines of a house shown schematically by a rectangle on the lower edge of which there is the icon of a house, or at any other access point on the ground), said user similarly being provided with a terminal (2″) for using the same e-commerce site (5), the communication goes through high-speed and inexpensive terrestrial access networks (3″) and through the networks forming the Internet on the ground (4).

In FIG. 2, a proxy server (6) is implemented in the airliner (A) so as to attempt to optimize the use of the Internet connection, an essential optimization when the airliner (A) is in flight and the communication uses satellite access networks (3) with limited speed at a high cost. It is now the proxy server (6) that generally uses the Internet access networks, be this the high-speed and inexpensive terrestrial access network (3′) when the airliner (A) is on the ground or the satellite access network (3) offering a limited speed at a high cost when the airliner is in flight, and no longer directly the terminal (2). However, it will moreover be seen that nothing changes with respect to FIG. 1, in particular in terms of the e-commerce server (5). The benefit provided by this approach is therefore limited.

FIG. 3 shows the implementation of the SeeS, which is the subject of the invention, consisting of an embedded component (8) in the airliner and a ground component (7). As the gearwheels (denoted E in FIG. 3) suggest, the two components (7) and (8) of the SeeS are designed and implemented to actively work together so as to optimize the use of the Internet connection that links them, which optimization is essential when the airliner (A) is in flight and the communication with the e-commerce server via the networks of Internet operators on the ground (4) uses satellite access networks (3) with limited speed at a high cost. Like the proxy server (6) in FIG. 2, it is generally the embedded component (8) of the SeeS that uses the Internet connection, be this via the high-speed and inexpensive terrestrial access network (3′) when the airliner (A) is on the ground or via the satellite access network (3) offering limited speed at a high cost when the airliner is in flight. Designed and configured to work with the ground component (7) and informed of the current flight phase by the computer system of the airliner (A), the embedded component (8) of the SeeS optimizes the use of the Internet connection that links it to the ground component (7), calling upon said ground component (7) differently depending on whether the communication goes through a terrestrial access network (3′) or through a satellite access network (3).

In addition, an Internet user (1″) in their home or at any other access point on the ground, equipped with a terminal (2″) and using the e-commerce site, will access a non-embedded component (8″) working with the ground component (7) in the same way as the embedded component (8) works. The embedded component (8) returns the responses to the https requests sent by the terminal (2) of the passenger (1). It thus constitutes the http server, that is to say the web server of the e-commerce site on the airliner (A). The non-embedded component (8″) performs the same function for the user in their home (1″).

A clear distinction should be made between the case of the passenger (1) of the airliner (A) on the ground, who goes through the embedded component (8) that collaborates via the Internet (4) with the ground component (7), and the case of the Internet user (1″) from their home, who uses the Internet (4) to access the non-embedded component (8″), which is usually placed in the same computer infrastructure as the ground component (7).

FIG. 4 shows one particular embodiment of the SeeS in which the non-embedded component (8″) of FIG. 3 is integrated into the ground component (7). This thus forms a novel component (9), performing the roles of the two components (7) and (8″) of FIG. 3: on the one hand, like the component (7), it works with the embedded component (8) so as to optimize the use of the Internet connection that links them (said embedded component (8) forming the web server of the e-commerce site in the airliner); on the other hand, it returns the responses to https requests sent by the terminals (2″) of the users (1″) in their home and constitutes the http server, that is to say the web server, of the e-commerce site for the Internet users (1″) using it from their home or at any other access point on the ground.

Method:

FIGS. 5 and 6 show a model of the operating sequences implemented by the device (SeeS) according to the invention.

FIG. 5 shows a model of the sequence of synchronizing the data and functions of the e-commerce site. The sequence is triggered at (10) by a task scheduler integrated into the embedded component (8) of the SeeS. In step 11, the computer system of the airliner (A) is called upon by the embedded component (8) of the SeeS to ascertain the current flight phase. In some phases, in particular take-off, the communication channels are reserved for the transit of flight-critical information. In step 12, the embedded component (8) tests whether the current phase allows communication, and if not, the sequence is interrupted at (13). In the opposite case, the embedded component (8) checks, at (14), whether or not the airliner is in flight. If the airliner is on the ground, a standard connection is available with high speed at a low cost: the embedded component (8) of the SeeS then asks (step 15) the ground component (7) for complete synchronization of the data and functions, which will complete without any problems in almost all cases, and the sequence stops at (16). In the opposite case, when the airliner is in flight, only an expensive and limited-speed satellite connection may be available. The device then evaluates, at (17) and (18), the status of this satellite link. In particular, at (17), the device interacts with the technical environment of the airliner to obtain status data on the satellite link, and, at (18), it tests whether a satellite connection is available. If this test in step (18) shows that such a satellite connection is actually available, the embedded component (8) of the SeeS asks (step 19) the ground component (7) for partial synchronization of the data, optimizing the use of the satellite connection, and the sequence stops at (20). The lower volume of data exchanged also increases the probability of the partial synchronization process completing successfully. Indeed, the satellite connection (3) may experience interference and interruptions. If, in step (18), satellite communication is not available when the SeeS needs it, the embedded component (8) keeps in buffer memory (step 21) the requests or the data that it would normally have transmitted to the ground component (7), so as to communicate them to the ground component in the next iteration triggered by the task scheduler.

FIG. 6 shows a model of the payment sequence following the synchronization of the data of a purchase transaction between a user terminal (2) and the e-commerce site. When a passenger reaches the end of their purchasing process and wishes, at (22), to pay for their purchase, the embedded component (8) of the SeeS interrogates, at (23), the status of the satellite link and attempts, at (24), to establish a connection with the ground servers of a payment service provider, which will conduct the transaction and thus finalize the purchase process at (25). The communication between the terminal of the passenger and the server of the partner, its progress and its content, will be the same whether the airliner is on the ground or in flight. The SeeS only intervenes in the event of a satellite connection being unavailable in step (24) to keep the transaction data in buffer memory (step 27) and to reattempt the payment after a delay (28). It is seen that, in this case, the mechanisms of the SeeS for optimizing the use of the Internet connection between its two components (embedded and on the ground) do not necessarily intervene. Indeed, this optimization might not be necessary in situations in which the data exchanged are of low volume, as is the case with payment operations.

### Exemplary Implementation

In one exemplary implementation of the invention, the e-commerce website is designed in the form of a single-page web application (“Single Page Application” or “SPA”) on the client side, running on the portable terminal (2) of the user or on a terminal integrated into the airliner by the equipment manufacturer. A single-page web application is a web application accessible via a single web page. The aim is to avoid loading a new page upon each requested action, and thus to streamline user experience.

In one embodiment, the embedded component (8) of the SeeS interrogates the ground component (7) via web services (question-answer exchange protocols between clients and servers on the Internet based on world wide web standards). According to the terminology in force and following a de-facto standard, the ground component of the SeeS exposes an API (Application Program Interface) in accordance with the REST (Representational State Transfer) standard that the embedded component consumes. This is a set of functions (or “endpoints”) accessible via the Internet and that the embedded component is able to interrogate in order to obtain data or trigger processing operations.

In one embodiment, the server forming the ground component (9) also allows the use of the e-commerce server on the ground and outside the airliner.

In the specific case where, as mentioned above, the website is designed in the form of a single-page web application and exposes an API, during use on the ground or outside the airliner, the application connects directly to the server and uses the API to retrieve data and to call the functions corresponding to the services of a shopping site.

In one embodiment, the embedded component (8) of the SeeS consists of an application taking the form of a technical component integrated into the in-cabin entertainment system (“In-flight Entertainment & Connectivity” or “IFEC”). Multiple types of deployment architecture may be used depending on the technical constraints set by the IFEC; mention may be made of the following conventional technical solutions: a servlet on a servlet server, a Docker container on a container orchestrator or a virtual machine on a hypervisor.

In one embodiment, the embedded component (8) of the SeeS operates according to the logic of a cache, ensuring updating thereof and the responses given to the client (in the “technical” sense) depending on the actions of the user. It uses for example “prefetches”, a complete process of updating the content of the cache by triggering an update request to the API of the ground component of the SeeS according to the values of the parameters of the airliner (flight status, weight on the landing gear Y/N, altitude, etc.).

In another embodiment, the embedded component (8) and the ground component (7) are both based on a search engine, a data storage system that offers sophisticated synchronization mechanisms and makes it possible to pre-compute, on the ground, some of the rules and functions required to offer the e-commerce service.

### Exemplary Application of the Invention to In-Flight Product Purchases

The device and the method according to the invention are particularly well suited for implementing an application for in-flight product purchases, in particular duty-free products.

The software application implementing the method will dynamically generate, for a given flight, catalogs of products offered for sale for this flight on the airliner along with all of the data needed for the correct operation of the e-commerce website for the end user and store them on board. These contents are images and text content in JSON format (for example descriptions of the products for sale).

When the airliner is in flight, all passengers accessing the e-commerce site from the SeeS via the Wi-Fi available on board the aircraft will then basically use only the data present in the embedded component. Only data that may be missing or that require updating in real time (for example stock or prices) will use the satellite connection of the aircraft in flight to access the ground component, along with data of limited size needed to conduct the transaction.

Products purchased in flight will be made available to clients at the arrival terminal of this airliner or delivered to their homes.

### Advantages of the Invention

The invention achieves the set aims. It allows a passenger to use an e-commerce site in an aircraft, to consult the catalog of items and to make purchases, with conventional telecommunications technologies and infrastructures that are already available. In particular, it does not require the addition of an external OWA module to user terminals. In the case of an e-commerce site, this is a significant difference, since it is of great importance to facilitate user experience as far as possible and to avoid any obstacle to purchase.

The implementation of the invention also does not require the installation of a meshed communication network between airliners, but it complies with a one-way chain of responsibility principle, that is to say that, to provide the service to a client A, the provider telecommunications operator does not involve its other clients, whose interests are potentially in competition with those of the client A. However, this principle is the only one able to avoid conflicts of interest that may lead to situations that are very complicated to manage legally, commercially and operationally.

In particular, by virtue of the invention, when the airliner is in flight, all passengers accessing the e-commerce platform via the Wi-Fi available on board the aircraft will then basically use only the data present in the embedded component. Only data that may be missing or that require updating in real time (for example product stock or the prices of said products) will use the limited and expensive Internet connection of the airliner in flight.

Once in flight, the method and the device according to the invention make it possible to update certain data (for example the prices or the availability of products for sale) at a frequency defined by the airline, thereby making it possible to keep recent data on board the airliner and reduce the necessary bandwidth.

In fact, the invention allows a substantial reduction, by a factor of around fifty (50), of the Internet bandwidth needed when the airliner is in flight, compared to the bandwidth needed without implementing the invention. This reduction results in a very significant reduction in costs for the airline and in an optimum shopping experience for users.

Ultimately, the invention makes it possible, with network and telecommunications technologies and infrastructures that are already available, to develop an efficient e-commerce sales channel with airline passengers during flight time. It allows both fast and fluid navigation via an e-commerce platform that is rich with numerous content and offers, while considerably reducing the use of satellite bandwidth, and therefore costs for the airline, in comparison with a conventional e-commerce site.

1. A device for passengers of an aircraft, comprising a set of computer terminals used by the passengers and an electronic commerce website itself comprising in particular servers hosted by a computer infrastructure located on the ground and capable of being interrogated from the aircraft by way of a limited-bandwidth direct communication link between the aircraft and the ground infrastructure without going through a communication network with other aircraft, wherein the electronic commerce website consists of a semi-embedded electronic commerce server (denoted “SeeS” for short) consisting of two parts, namely, on the one hand, a component located on the ground and, on the other hand, a component embedded in the aircraft and configured to optimize communication with said ground component depending on the various phases of a flight.

2. The device according to claim 1, wherein said computer terminals use communication protocols that are local network protocols, in particular Wi-Fi and Ethernet protocols.

3. The device according to claim 1, wherein said limited-bandwidth direct communication link is a satellite communication link or a direct radiofrequency connection from the ground.

4. The device according to claim 1, wherein said embedded component is configured to retrieve, automatically and in real time, information about the current flight phase.

5. The device according to claim 1, wherein the data exchanges between the two components of the SeeS are differentiated according to flight phases, taken from among parked in the closed flight state, parked with flight open, passenger boarding, taxiing, take-off and climbing to cruising altitude, cruising phase, descent and landing, passenger disembarkation.

6. The device according to claim 1, wherein said embedded component is configured to automatically retrieve information regarding the airliner, the flight and the passengers, taken from among the following elements: unique identifier of the airliner (“tail number”), flight number, flight characteristic data (such as departure and arrival airports, departure time and scheduled arrival time), flight parameters, and, for each passenger: confidential personal data such as identifier, segments of the trip, connecting airports, return flights, next trips, next places of residence, loyalty card number.

7. The device according to claim 1, wherein said embedded component is configured, when the aircraft is on the ground, to download, from the ground component, high-volume data such as product catalogs, or updates to functions or the software of the embedded device, using said high-bandwidth direct Internet connection between the aircraft and the ground infrastructure.

8. The device according to claim 1, wherein said embedded component is configured, when the aircraft is in flight, to communicate with the ground component using said limited-bandwidth direct communication link to exchange low-volume data with said ground component.

9. The device according to claim 8, wherein said low-volume data comprise personal and confidential information related to the creation of user accounts, user authentication, real-time stock of products available on the electronic commerce site, validation of shopping carts or finalization of payment transactions, and information on differential updates to the data of the electronic commerce website.

10. The device according to claim 1, wherein said two components of the SeeS are configured to implement copying, “caching”, “prefetching”, replication, cloning, synchronization, API and load distribution operations, so as to optimize the use of the Internet connection available between them in real time.

11. The device according to claim 1, wherein said computer terminals of the users comprise personal computer terminals such as smartphones, touchscreen tablets or laptops.

12. The device according to claim 1, wherein said computer terminals of the users comprise terminals integrated into the entertainment system on board the aircraft.

13. The device according to claim 1, wherein said embedded component and the ground component of the semi-embedded electronic commerce server are configured to encrypt the communication between them.

14. The device according to claim 1, wherein said electronic commerce website is designed in the form of a single-page web application running on the portable terminal of the user or on a terminal integrated into the airliner.

15. The device according to claim 1, wherein said embedded component is configured to test the availability of a direct connection between the computer network of the airliner and the ground component, allowing the computer network of the airliner to access the ground component immediately and without delay and, in the event of unavailability, to save the transactions of the users in a buffer memory so as to complete them when the connection is available again or via a ground communication link once the aircraft has landed.

16. A method for implementing the device according to claim 1, including steps of:
interacting with the computer system of the airliner to check whether direct and immediate radiofrequency communication with the ground infrastructure is permitted;
if so, for the embedded component of the device, checking, using the computer system of the aircraft, the status, in flight or on the ground, of the aircraft;
if the aircraft is on the ground, launching a complete data synchronization phase between the ground component and the embedded component using a high-bandwidth terrestrial communication link;
if the aircraft is in flight and a limited-bandwidth satellite communication link is available, launching a partial data synchronization phase between the ground component and the embedded component.

17. A method according to claim 16, wherein the partial synchronization phase concerns low-volume data such as personal and confidential information related to the creation of user accounts, user authentication, validation of shopping carts or finalization of payment transactions.

18. A method according to claim 16, wherein the partial synchronization phase concerns low-volume data such as information related to the real-time stock of products available on the electronic commerce site, or differential updates to the data of the electronic commerce website.
